(19) United States
(12) Patent Application Publication
(10) Pub. No.: US 2011/0104352 A1
(43) Pub. Date: May 5, 2011

(54) Health-Food Product with Mixed-In Concentrated Guava-Leaf Extract of Savoriness Improved by Cereal Grain

(75) Inventors: Shigeaki Akamatsu, Ichikawa-shi (JP); Tsunenori Ogane, Tokyo (JP)

(73) Assignees: ECO BUSINESS CO., LTD., Ichikawa-shi, Chiba (JP); Non-Profit Organization Japan Patent Research Associates, Tokyo (JP)

(21) Appl. No.: 12/444,391

(22) PCT Filed: Oct. 7, 2008
(86) PCT No.: PCT/JP2008/068523

§ 371 Date: Apr. 4, 2010

(51) Int. Cl. A23L 1/221

(52) U.S. Cl. 426/536

(57) ABSTRACT

In the proper quantity intake of the extract element of the Guava leaf origin, we can achieve a health food of the grain base with easily.

Health food that composed of 70-150 mg of Guava leaf polyphenol of water solubility with digestive enzyme controlling effect in concentrated extract which is adjusted to more than at least 70% to 100 g of grainy or powdered grain.

### TECHNICAL FIELD

This invention provides new health food daily ingestible based on concentrated extract element of various grain originated from Guava leaf which effect is expected of hyperlipemia measures and high blood sugar level syndrome measures without losing tasting character.

### BACKGROUND ART

It is widely known as various commodities of the extract elements of the Guava leaf origin for the consumer who has high consideration in health maintenance assuming that the effect can be expected of the cancellation or easing various symptoms such as hyperlipemia of yellow tumor and high blood sugar level syndrome of diabetics.

That is, food and drink goods in which the effect of a healthy improvement of Guava leaf origin element is expected have been being marketed for about at least 20 years. And various commodities are developed by the sales technique using actual store, mail order, and Internet for a general consumer.

Moreover, in recent years, a quick, certain medicine efficacy is admitted for the medicines from which the effect is expected by a scientific synthetic means, however, it is also generally recognized that it likely to cause harm unexpectedly.

Therefore, various, natural material origin that proven to be effective in daily use from a long time ago has been reviewed and began to be used effectively.

It has been known that Guava leaf extraction element of the South America Amazon origin has various, healthy effects by taking it daily for at least hundreds of year or more in the locale.

And, the extraction technology to industry commercialize this effective extract element is researched and developed still now. The technology that concentrate the polyphenol element of the Guava leaf origin by the water solubility have been put to practical use.
Patent Document 1: Japanese Unexamined Pat. App. Pub. No. H11-103817.
Patent Document 2: Japanese Pat. No. 4,109,731.

### DISCLOSURE OF INVENTION

### Problem Invention is to Solve

It has been affirmed at least at experiential and statistical level that the effect of various, healthy improvements by taking the extract element of the Guava leaf origin in the proper quantity is expected.

Moreover, though the Guava leaf is comparatively cheap, there is a reason not necessarily widespread in general. That is, the Guava leaf extract element has stinky and peculiar bitterness and Egumi (bad taste), and it is very difficult to take this as an amount to be able to expect the effect of a healthy improvement every day.

So it is not an exaggeration to say that it is impossible for people especially in advanced nations that have improved the food circumstances to take a Guava leaf extraction element a prescribed amount daily.

### Means for Resolving the Problems

This invention was created as a result of piling up inventor's long years of study to solve the problem in such a prior art. A special further concentrated process is passed, and a conventional guava leaf extract element is assumed the weight of about ⅛- 1/10. The amount of the element of an effective Guava leaf origin polyphenol element is adjusted more than prescribed %.

As a result, the inventor finds the reduction even to extent where man hardly feels a peculiar stinky and bitterness and Egumi (bad taste).

And by using this, they succeeded in the development of the health food that was able to take daily the Guava leaf origin concentrate extract element that was mixed with food based on grain in the proper quantity.

It is concretely as follows:

(1) Health food that improves tasting character to grain by mixing concentrated Guava leaf extract, which controls the generation of sugar when digesting and absorbing, the absorption of sugar to the enteric canal is suppressed, and it leads to effective obesity prevention, composed of 70-150 mg of Guava leaf polyphenol of water solubility with digestive enzyme controlling effect in concentrated extract which is adjusted to more than at least 70% to 100 g of grainy or powdered grain.

(2) Health food that improves tasting character to grain by mixing concentrated Guava leaf extract, which Described in claim 1, characterized by mixing about 2 g of medicine for intestinal disorders such as hard digestibility dextrins.

(3) Health food that improves tasting character to grain by mixing concentrated Guava leaf extract, which Described in (1) or (2), characterized by the processing foods such as noodle or bread which controls the generation of sugar when digesting and absorbing, the absorption of sugar to the enteric canal is suppressed, and it leads to effective obesity prevention, by kneading the concentrated Guava leaf extract to powdered grain such as flour.

(4) Health food that improves tasting character to grain by mixing concentrated Guava leaf extract, which Described in (1) or (2), characterized by improving sweetness and the umami element to cooked or boiled rice, composed of 70-150 mg of Guava leaf polyphenol of water solubility with digestive enzyme controlling effect in concentrated extract which is adjusted to more than at least 70% to 100 g of polished rice.

(5) Health food that improves tasting character to grain by mixing concentrated Guava leaf extract, which Described in (4), characterized by rice meal boiled with other ingredients.

(6) Health food that improves tasting character to grain by mixing concentrated Guava leaf extract, which Described in (3), without losing sweetness, the umami, and the flavor of Noodles such as noodles and ramen, bread and cake by kneading the concentrated Guava leaf extract to powdered grain such as flour, rice powder, and cornmeal.

### Effects of the Invention

(a) By mixing 70-150 mg of Guava leaf polyphenol of water solubility with digestive enzyme controlling effect in concentrated extract which is adjusted to more than at least 70% to 100 g of grainy or powdered grain, we can contain the Guava leaf origin concentrate extract element of the proper quantity which is expected the effect of a healthy improvement in a prescribed amount of the grain that the adult in general takes as staple food 1-3 time. So it can be provided as a daily meal.

In a word, it is known that taking the amount of about 200 mg in a day is necessary to expect the effect of the Guava leaf polyphenol for the adult in general.

To meet this requirement with the meal of three times a day, the inventor confirmed it only had to adjust it so that 70-150 mg of Guava leaf polyphenol of was included to the 100 g of food based on the grain as staple food.

So if it is less than this amount, an enough effect cannot be expected, and if it is more than this amount, the effect is saturated.

By concentrating it so that the Guava leaf extraction polyphenol element become at least 70% or more, it is confirmed to reduce it even to extent where man hardly feels a peculiar stinky and bitterness and Egumi (bad taste) of Guava, even if you contain the Guava leaf polyphenol element of a necessary amount in the staple food grain food of one meal.

In general, the original element of stinky and bitterness and the Egumi thickens when the extract is concentrated.

For the Guava leaf polyphenol adopted by this invention, it is considered that the effect of the filter was achieved. As a result, the amount decreases in the element that becomes the origin of stinky and bitterness and the Egumi. It can be understood that it fell below the critical mass that man is unpleasant.

By the concentrate of 70% or less, it cannot be said that an enough element decrease in stinky and bitterness and the Egumi tast. On the other hand, when this is greatly exceeded and concentrated, the working line becomes complex and the cost profit cannot be taken. So the concentrate of about 70-75% is suitable in this invention.

Most conventional, general Guava leaf origin element is non-water solubility when making it like the powder.

Though it was disadvantageous when this is added to food, the one adopted in this invention is a thing water solubility made like the powder, which is easy to treat when adding to food and the drinks.

Therefore, it could be easily achieved that effective obesity prevention that controls generation of sugar when digesting and absorbing it, controls absorption of sugar to enteric canal which are expected as an effect of the Guava leaf polyphenol.

(b) By further mixing about 2 g of medicine for intestinal disorders such as hard digestibility dextrins, effective prevention of the trouble of the activity of intestines that might sometimes be caused becomes possible.

The already-known one can be changed properly and the intestinal disorders medicine element added here adding it be used by mixing it, according to various symptoms that may be caused.

(c) By kneading the concentrated Guava leaf extract to powdered grain such as flour, it can controls the generation of sugar when digesting and absorbing, the absorption of sugar to the enteric canal is suppressed, and it leads to effective obesity prevention. As a result, effectively applying this invention to the processing food based on popular grain powders becomes possible.

(d) By mixing cooked or boiled rice with 70-150 mg of Guava leaf polyphenol of water solubility with digestive enzyme controlling effect in concentrated extract which is adjusted to more than at least 70% to 100 g of polished rice.

It becomes possible to Apply this invention to the meal of rice which is familiar for the Japanese and has come to be accepted for various foreigner person without the sense of incompatibility by a recent Japanese food boom.

(e) In addition, by adding other food materials to rice, the application of this invention that tempers with the effect of nourishment of other food materials and the effect on the taste becomes possible.

(f) By kneading the concentrated Guava leaf extract to powdered grain such as flour, rice powder, and cornmeal etc, It became the one that sweetness, the umami, and the flavor of noodles and pancakes such as udon and ramen are not ruined. Therefore, the commodity of a healthy intention developing while decreasing the excessive intake for the calorie and fat fear for popular noodles, pastas, various bread, and the cakes, etc. becomes possible.

### BEST MODE FOR CARRYING OUT THE INVENTION

The example of a concrete embodiment of this invention that has been recorded is described easily as follows.

The tasting character was improved so that it was eaten easily every day even if the Guava leaf extract element was added to food based on grain. And, from this viewpoint, it is proved the healthy improvement of the Gaba leaf extract element.

### Embodiment 1

While meeting the requirement of this invention, boiled cleaned rice is the sample of example 1. As a comparison example, Guava leaf extract element sample in state that is not concentrated and the drink beverage commodity that contains Guava leaf extraction element on the market are prepared.

Cleaned rice was boiled with the rice cooker similarly after the blending quantity had been adjusted to contain the Guava leaf extraction extract element at the same rate as example 1. It was assumed to be example 2 of comparing the use of Guava leaf extract content drink beverage commodity that the comparison example 1 and was on the market to use a past Guava leaf extract.

Cleaned rice could be usually boiled without changing the condition of cooking rice

Moreover, it actually tries to five monitors, and having been taken as a consensus is as follows.

The difference on externals of the rice cooked is:

example 1 Considerably dark brown by the Guava leaf extract element
example 2 more thinly than example 1

It was confirmed from example 1 by the thinness of the extent about which it was not anxious.

About the smell, both examples 1 and 2 is stinky obviously peculiar to Guava, though comparison example 2 seemed to be weakened somewhat. It seemed that an obviously healthy appetite was reduced, and it was difficult to keep eating as a daily eating.

Example 1 was the one of the extent thought not to be able to know so if said that would have added the Guava element, and the smell to reduce the appetite was not felt at all.

Examples 1 and 2 cannot be eaten without that you do not think that it is a medicine taken when getting sick because there are obviously a peculiar both bitterness and Egumi tastes to Guava.

On the other hand, though the example 1 of this invention is different from a certainly pure cleaned rice, it is the one of the accent on the taste, it is the one of the accent on the taste and the one of the extent that can consent if said that it is Chameshi (tea rice) with externals dyed to the pale brown. So you need not especially feel some psychology resistance even if eating as staple food of every day.

### Embodiment 2

With the cooperation of diabetes as the monitor, the Guava leaf polyphenol element of about 70 mg was taken at a meal from Aug. 17, 2008 and the data is collected by the specialist. The result is the following Table 1.

TABLE 1
Diabetic's clinical trial data by specialist

| Trial | Normal | | | | | | |
|---|---|---|---|---|---|---|---|
| Name | value | Unit | 2008 Mar. 5 | 2008 Apr. 9 | 2008 May 21 | 2008 Aug. 13 | 2008 Sep. 17 |
| GLU | 60~109 | mg/dl | 143 H | 161 H | 144 H | 114 H | 122 H |
| (glucose) | | | | | | | |
| After | | | Hungry | Hungry | Hungry | Hungry | Hungry |
| the meal | | | time | time | time | time | time |
| HbAlc | 4.3~6.8 | % | 7.7 H | 7.6 H | 7.8 H | 7.7 H | 7.2 H |

HbAlc figure declined to 7.2H from 7.7H in several months after monitor started to take this. Now we are going to continue this monitoring, it is possibility to find new effects.

### INDUSTRIAL APPLICABILITY

According to this invention, that has been described above. Though the various, healthy improvement effect is known since before, It was in fact impossible to take a necessary amount the Guava leaf polyphenol element for the stinky and peculiar bitterness and Egumi taste every day.

By this invention, it comes to be able to take it continuously as health food by adding to food based on grain easily. Since the application to various foods is expected, it can be understood that it has a large industrial applicability.

1. A health-food product with mixed-in concentrated guava-leaf extract of savoriness improved by a cereal grain, characterized in that: per 100 g of cereal in granular or powdered form, 70-150 mg of guava-leaf polyphenols, having digestive-enzyme controlling efficacy, within a concentrated extract in which water-soluble guava-leaf extract polyphenol components have been adjusted to at least not less than 70%, is mixed with the cereal and the mixture prepared as a food, to control generation of sugars during digestion/absorption and limit absorption of sugars into the intestinal tract; wherein consideration is given so as to lead to effective prevention of obesity.

2. A health-food product with mixed-in concentrated guava-leaf extract of savoriness improved by a cereal grain, as set forth in claim 1, characterized in being mixed together further with about 2 g of an indigestible dextrin or other medicinal ingredient for regulating the bowels.

3. A health-food product with mixed-in concentrated guava-leaf extract of savoriness improved by a cereal grain, as set forth in claim 1, characterized in that the concentrated guava-leaf extract is powdered and kneaded into a powdered cereal grain such as wheat flour to thereby render a processed foodstuff such as noodles or bread, to control generation of sugars during digestion/absorption, limit absorption of sugars into the intestinal tract, and lead to effective prevention of obesity.

4. A health-food product with mixed-in concentrated guava-leaf extract of savoriness improved by a cereal grain, as set forth in claim 1, characterized in that per 100 g of white rice, 70-150 mg of guava-leaf polyphenols, having digestive-enzyme controlling efficacy, within a concentrated extract in which water-soluble guava-leaf extract polyphenol components have been adjusted to at least not less than 70% is mixed in, improving the sweetness and tastiness components of the cooked, as-boiled white rice.

5. A health-food product with mixed-in concentrated guava-leaf extract of savoriness improved by a cereal grain, as set forth in claim 4, characterized in being rendered a dish in which other ingredients have further been added and boiled in with the rice.

6. A health-food product with mixed-in concentrated guava-leaf extract of savoriness improved by a cereal grain, as set forth in claim 3, characterized in that the concentrated guava-leaf extract, made as aforesaid, is powdered and kneaded into a powdered cereal grain such as wheat flour, rice flour, or cornmeal to thereby render an udon, ramen or other noodle product, or a bread or cake product, in which the sweetness, tastiness and flavor is unspoiled.

7. A health-food product with mixed-in concentrated guava-leaf extract of savoriness improved by a cereal grain, as set forth in claim 2, characterized in that the concentrated guava-leaf extract is powdered and kneaded into a powdered cereal grain such as wheat flour to thereby render a processed foodstuff such as noodles or bread, to control generation of sugars during digestion/absorption, limit absorption of sugars into the intestinal tract, and lead to effective prevention of obesity.

8. A health-food product with mixed-in concentrated guava-leaf extract of savoriness improved by a cereal grain, as set forth in claim 2, characterized in that per 100 g of white rice, 70-150 mg of guava-leaf polyphenols, having digestive-enzyme controlling efficacy, within a concentrated extract in which water-soluble guava-leaf extract polyphenol components have been adjusted to at least not less than 70% is mixed in, improving the sweetness and tastiness components of the cooked, as-boiled white rice.

9. A health-food product with mixed-in concentrated guava-leaf extract of savoriness improved by a cereal grain, as set forth in claim 8, characterized in being rendered a dish in which other ingredients have further been added and boiled in with the rice.

10. A health-food product with mixed-in concentrated guava-leaf extract of savoriness improved by a cereal grain, as set forth in claim 7, characterized in that the concentrated guava-leaf extract, made as aforesaid, is powdered and kneaded into a powdered cereal grain such as wheat flour, rice flour, or cornmeal to thereby render an udon, ramen or other noodle product, or a bread or cake product, in which the sweetness, tastiness and flavor is unspoiled.
